(19) United States
(12) Patent Application Publication
(10) Pub. No.: US 2004/0141883 A1
(43) Pub. Date: Jul. 22, 2004

(54) Apparatus for removing and depositing microarrays of solutions

(76) Inventors: Gabriel Abba, Walscheid (FR); Philippe Kastner, Fogersheim (FR); Stanislas Du Manoir, Strasbourg (FR); Bernard Jost, Strasbourg (FR)

Correspondence Address: YOUNG & THOMPSON, 745 SOUTH 23RD STREET 2ND FLOOR, ARLINGTON, VA, 22202

(21) Appl. No.: 10/468,871

(22) PCT Filed: Feb. 22, 2002
(86) PCT No.: PCT/FR02/00669

(30) Foreign Application Priority Data
Feb. 23, 2001 (FR) 0102509

(51) Int. Cl. B01L 3/02

(52) U.S. Cl. 422/100; 436/180

(57) ABSTRACT

The invention relates to an apparatus (1) for removing and depositing micro-drops (2′) of solutions from/on a surface (2), in particular chemical or biological solutions. The inventive apparatus comprises at least one micropipette or deposit point (3) which is mounted on a head (4) that can move in at least one direction, at least between one or more removal sites (5) and one or more deposit sites (6). Said apparatus is characterised in that the micropipette(s) (3) are mounted in the body of said head (4) and they can be moved in translation in relation to said head, by means of a device for controlling and limiting the application force of the micropipette(s) (3) on the deposit surface (2). Said controlling and limiting device is connected to a device for guiding said micropipette(s) in translation in relation to the head (4), while they are in contact with said surface (2) or in order to bring them into contact with said surface (2).

This invention relates to the field of controlled sampling and depositing of substances by a device or a similar electromechanical system, in particular for depositing on a surface a large number of molecules of different chemical or biological products (solutions of ADN, proteins, chemical reagents or others) and has as its object a device for sampling and depositing on a surface solutions of very small quantities in the form of (a) high-density microdrop network(s).

Several devices that produce deposits of liquid substances in the form of microdrops on diverse surfaces already currently exist.

These known devices can be distributed into two separate groups based on the deposit method that is used, namely the devices that produce the deposition by physical contact between the sampling element and the surface of the deposit and those that produce the deposit without physical contact, i.e., by spraying.

Now, each of the two types of devices exhibit drawbacks and limitations that constitute obstacles to a reliable and long-lasting use of said devices.

The known devices that operate by physical contact actually do not have any effective means for limiting the pressure of contact between the sampling element and the deposit surface; there thus relatively quickly results a deterioration of said elements and/or of the deposit surface and therefore unreliable reproducibility in terms of precision of consecutive deposits, because of a modification of the geometry and the configuration of said elements and of said surface, in addition to a contamination of substances that are deposited by debris or by previously sampled substances because of incomplete cleaning of the jagged elements.

These problems are particularly apparent during the use of split-point elements that because of their actual shape allow neither a satisfactory cleaning nor a satisfactory reproducibility in size and in geometry of the deposited drops.

Similar problems appear with the devices in which the deposits are made by stamping films by cylindrical deposition points.

Furthermore, the known devices that carry out the deposit by spraying do not make it possible to control the shape of the sprayed drop nor specifically the quantity of substance that is deposited by drop. In addition, such a spraying can, in some cases, end in the explosion of the sprayed drop and therefore the contamination of adjacent drops and/or the surface that extends between said deposited drops. This technique consequently is not suitable for a quantitatively controlled high-density deposit.

This invention has as its object to remedy at least some of the drawbacks and limitations of the above-mentioned existing devices and to propose a device that makes it possible to carry out high-density micronetworks with good reproducibility in a high-performing and reliable manner.

For this purpose, the invention has as its object a device for sampling and deposition on a surface, in the form of microdrops, of, in particular, chemical or biological solutions that comprise at least one micropipette or deposition point that is mounted on a moving head in at least one direction, at least between one or more sampling site(s) and one or more deposition site(s), characterized in that the micropipette or micropipettes are hollow and are mounted in the body of said head, with relative transportability relative to the latter, via a device for monitoring and limiting application stresses of the micropipette or micropipettes on the deposit surface, combined with a device for guiding the latter relative to said head, during or for the purpose of bringing them into contact with said surface.

Sampling and deposition sites will advantageously be placed in a flat matrix arrangement on plates or in corresponding respective receptacles.

The moving head can, for example, be movable in two perpendicular directions by being mounted on a stationary support structure, and the plates or receptacles that receive said sites are then independently mobile in directions that are parallel to one another and perpendicular to the plane that contains the two directions of travel of the moving head or micropipettes that are mounted on the latter.

As a variant, it can be provided that the head is supported by a structure that is itself mobile in a direction that is perpendicular to the plane that contains the two directions of travel of the moving head (for example an arm or a translating gantry), whereby the plates or receptacles are then fixed.

When the head is mobile only in one direction, it can be provided that said plates or receptacles are mobile in two perpendicular directions in a plane that is orthogonal to the direction of travel of the head or that said plates or receptacles are mobile in one direction and that the support structure of the head is equally mobile in another direction, whereby the three directions of travel are perpendicular two by two.

In any case, the moving head will exhibit three degrees of freedom relative to the sampling site(s) and/or the deposition site(s).

In a preferred manner, each micropipette exhibits a body that may or may not be cylindrical, longitudinally traversed by a channel and that exhibits a tapered end, for example of an essentially conical shape, ending by a terminal contact surface that is annular and plane.

To be able to control in a reliable manner the shape and the dimensions of the drop to be deposited, the tapered end has, before coming out on the terminal contact surface, a connecting surface that produces a continuous passage between the conical surface of the tapered end and the planar contact surface, advantageously generated by a portion of parabolic curve.

The micropipette can, for example, exhibit a cylindrical body that narrows in a conical manner at its free end or deposition tip.

As a variant, each micropipette can be provided, at its free end or deposition tip, with an essentially annular protuberant formation that may or may not be circumferentially continuous and that surrounds the tapered end and that is separated from the latter by an annular reinforcing zone that is formed or provided in said end of the body of the micropipette that is being considered, whereby said annular protuberant formation ends in a planar terminal contact surface, located in a parallel plane, and if necessary, combined with the plane that comprises the contact surface of the tapered end.

These contact surfaces can be shifted among one another in the longitudinal direction of the body of each micropipette, and, in this case, the deposition sites are located in hollows or corresponding supports.

According to the invention, the guiding device, specific to each micropipette or common to all micropipettes, can ensure only simple guiding at a unique guiding surface, but, to obtain a better precision of movement and positioning, it will advantageously ensure a double guiding of the body of each micropipette, at two guiding zones of translational motions spaced relative to the moving head in the body of which it is mounted (release of an intermediate space for sensors and/or actuating elements).

According to a first embodiment of the invention, each device for monitoring and limiting stress consists of a passive, compliant device, such as an elastically flexible or compressible intermediate element that ensures controlled transmission of thrust loads and the translational motion between the body of the moving head and the micropipette in question.

According to a second embodiment of the invention, each device for monitoring and limiting stress consists of an active device in the form of an actuator that is integral with the moving head, acting directly on the body of the micropipette that is being considered or on a transmission part of loads formed or fixed on the latter in view of being brought into contact with the surface and monitored by means of a loop for regulation and closed-loop control that also integrates a means for measurement or direct or indirect determination of the application force of said micropipette on the deposit surface.

According to a third embodiment of the invention, each device for monitoring and limiting stress consists of a mixed device that integrates an actuator that is controlled by a loop for regulation and closed-loop control that integrates a means for measurement or direct or indirect determination and acts on the associated miropipette via a passive compliant device.

The determination of the application force can, for example, be carried out by an indirect measurement, by observation and/or estimation.

Advantageously, the quantity of liquid that is sampled and deposited by each micropipette is monitored via means that produce a variation of pressure of a gas at the end of the micropipette opposite its free end or deposition tip.

The invention will be better understood, thanks to the description below, which relates to preferred embodiments, given by way of non-limiting examples and explained with reference to the attached schematic drawings, in which:

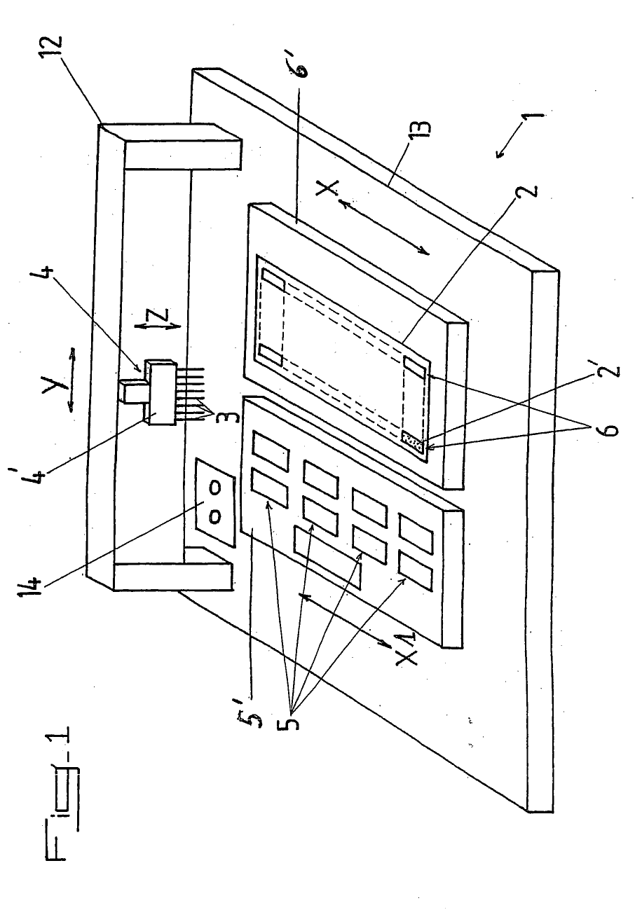

FIG. 1 is a diagrammatic view in perspective of an embodiment of the device according to the invention;

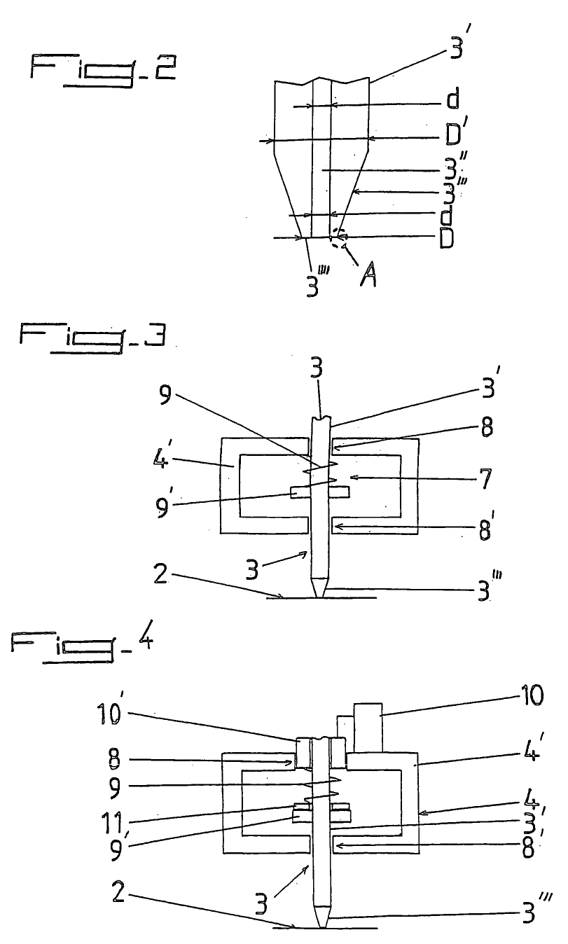

FIG. 2 is a transparency view and on a scale that is different from a portion of a micropipette that is part of the device that is shown in FIG. 1;

FIG. 3 is a side cutaway view of a portion of the moving head that is part of the device that is shown in FIG. 1 and in which a micropipette is mounted, in connection with a passive compliant device;

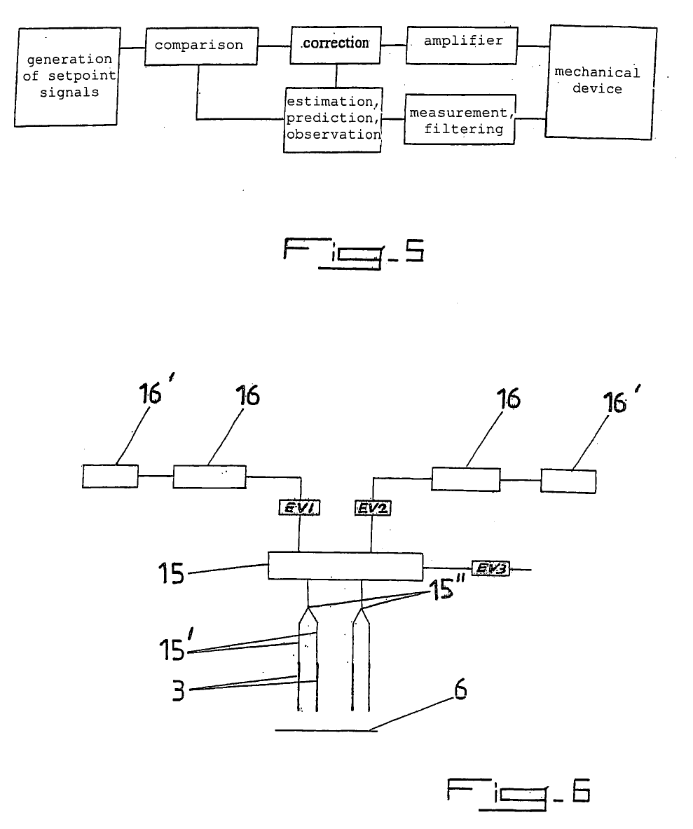

FIG. 4 is a side cutaway view of a portion of the moving head that is part of the device that is shown in FIG. 1 and in which a micropipette is mounted, in connection with a device for mixed monitoring and limiting of stress;

FIG. 5 is a synoptic diagram that shows in the form of block functions a possible structure of a loop for regulation and closed-loop control of force that can be used in the device according to the invention;

FIG. 6 is a diagrammatic representation of the fluid circuit that is combined with the moving head that is part of the device according to the invention;

FIG. 7 is a view, on a different scale, of detail A of FIG. 2 (the shape of the deposited drop is shown in dashes);

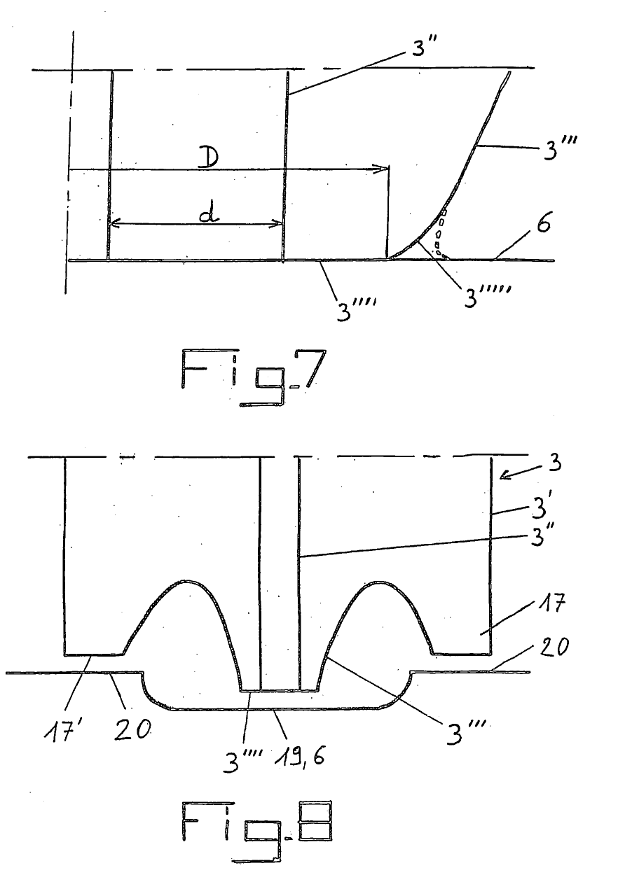

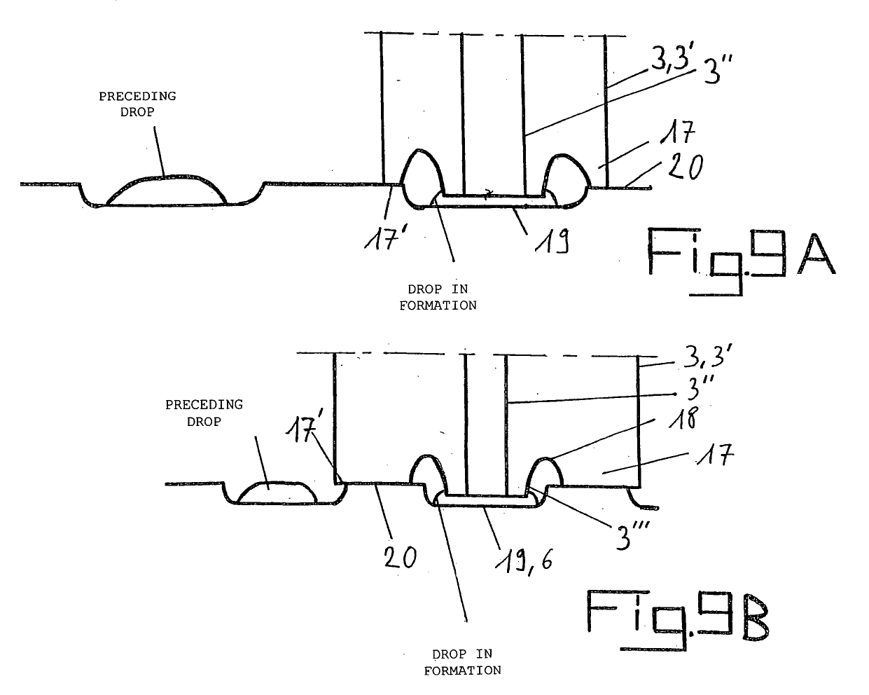

FIG. 8 is a view that is similar to that of FIG. 2 of a variant embodiment of the end of a micropipette that is part of the device that is shown in FIG. 1, and,

FIGS. 9A and 9B are diagrammatic representations that show the deposition of a drop on two substrates that have deposition sites with different spacing, with a micropipette according to FIG. 8.

As the figures of the attached drawings show, device 1 for sampling and for deposit on surface 2 in the form of microdrops 2′ of, in particular, chemical or biological solutions, comprises at least one micropipette or deposition point 3 that is mounted on a moving head 4 in direction Y or Z or two different directions Y and Z, at least between one or more sampling site(s) 5 and one or more deposition site(s) 6.

Head 4 is preferably mounted so as to be able to move in two directions Y and Z on a support structure of fixed gantry type 12, and plates or receptacles 5′ and 6′, respectively receiving sites 5 and 6, can move independently in parallel directions X and X1, whereby the unit is installed on a fixed support plane 13.

Micropipette or micropipettes 3 are mounted in the body of said head 4, with relative transportability relative to the latter, via a device 7 for monitoring and limiting application stresses of micropipette or micropipettes (3) on deposit surface (2), combined with a device 8, 8′ for guiding of translational motions of the latter relative to said head (4), during or for the purpose of bringing them into contact with said surface 2.

Device 1, as shown in the attached figures, also comprises, on the one hand, an arm or a gantry 12 that carries moving head 4 and allows at least its travel along an axis or the travel of micropipettes 3 in a plane, preferably in two orthogonal directions Y and Z, and, on the other hand, a support plane 13 (of a table or a similar piece of furniture) on which are placed sites 5 for sampling solutions, for example in the form of small plates, wells or similar containers, sites 6 for the deposit in micronetworks of microdrops 2′ of solutions sampled by micropipettes 3 and a site or a station 14 for evacuation and washing of said micropipettes 3, whereby arm or gantry 12 can be translated in a direction X that is approximately perpendicular to the plane Y, Z for travel of moving head 4 or micropipettes 3 that are mounted on the latter.

Advantageously, device 1 consists of a programmable robot whose arm in gantry form 12 that supports moving head 4 moves relative to the ratio of fixed support plane 13 or whose plates or receptacles 5′ and 6′ travel relative to said plane 13, whereby arm 12 is fixed.

FIG. 1 defines the different possible axes of movement for moving head 4, namely longitudinal travel (X, X1 axes) via gantry 12 or plates 5′ and 6′, transversal travel (Y axis) by translation of the head to the support bar of said gantry 12, and vertical travel (Z axis) for sampling or deposition.

It will be noted that the travel for the purpose of deposition can result from just the travel of moving head 4 (passive device 7) or the combination of a first coarse travel of moving head 4 and a final fine travel of each micropipette or deposition point 3 by an actuator 10 (active or mixed device 7).

Deposition head 4 advantageously consists of four subassemblies: deposition points 3, a device 8, 8′ for guiding and specific positioning, a device 7 for monitoring contact stresses and a unit consisting of capillaries and a pressure chamber (not shown specifically) that make possible the monitoring of the pressure inside deposition points 3.

Deposition head 4 makes it possible to deposit drops 2′ of predefined shape (circular in most cases) with a great regularity and a very good repeatability and is provided with one or more micropipettes or points 3. Preferably, as FIG. 1 shows, moving head 4 comprises a number of micropipettes 3 that are arranged in rows and columns according to a two-dimensional matrix structure. The number of points 3 should be compatible with the size and the density of drops 2′ of the micronetwork that is to be produced.

The table below provides, by way of non-limiting indications, possibilities for use of multiple-point heads according to the invention. Deposition head 4 makes it possible to monitor the exact volume that is sampled in each well and to carry out an effective washing (contamination rate less than 0.1%) between two consecutive loadings.

| | 1 | 2 | 4 | 8 | 16 |
|---|---|---|---|---|---|
| Head | Point | Points | Points | Points | Points |
| Minimum | 1 | 24 | 576 | 576 | 576 |
| number of | | | | | |
| solutions | | | | | |
| Density = 700 drops/cm2 | | | | | |
| Minimum | 1 | 36 | 1296 | 1296 | 1296 |
| number of | | | | | |
| solutions | | | | | |
| Density = 1600 drops/cm2 | | | | | |

Deposition points 3 that are used have a hollow cylindrical shape (cylindrical body 3′ longitudinally traversed by a channel 3″) as FIGS. 1, 3 and 4 show. Outside diameter D′ of body 3′ (having no impact on the dimension of the drops) should allow a good acquisition and specific guiding of the point, whereby the latter is cone cut at one 3′″ of its ends.

FIG. 2 shows a sketch of the embodiment of a deposition point 3. The conical portion (its specific shape and its slope are not important) makes it possible to reduce the diameter and to pass from outside diameter D′ to terminal diameter D (outside diameter of the terminal contact surface 3″″), whereby the latter is of the same order of magnitude as the diameter of drops 2′ to be deposited (a diameter of 150 μm leads to drops with a diameter of 180 μm, for example).

Connector surface 3′″″ (portion of the outside surface of the micropipette that is wetted during contact of the latter with the deposit surface) between tapered portion 3′″ and the terminal contact surface 3″″ can be conical or have another shape. It is possible, for example, to want to optimize the size of the drops based on variations of viscosity or surface tension of solutions that will require a particular shape and configuration of tapered portion 3′″ and connector surface 3′″″.

Said connector surface 3′″″ preferably makes a continuous pass between the conical surface of tapered end 3′″ and planar contact surface 3″″, advantageously generated by a parabolic curve portion.

As FIG. 7 of the attached drawings shows, by way of example, connector surface 3′″″ should advantageously make possible the progressive passage of planar and cylindrical terminal surface 3″″ to conical surface 3′″. It is thereby necessary to have a tangent connection and a progressive variation of the slope.

Inside diameter d influences two essential parameters of the deposit process, namely the contact pressure between the tip and the deposit surface and the speed of the washing process. To ensure a good compromise between these two parameters, the value of inside diameter d is preferably located between 0.2 and 0.8× the value of terminal diameter D.

Guiding device 8, 8′ makes it possible for deposition points 3 to slide freely along an axis that is perpendicular to deposit surface 2. One skilled in the art will note that only the final movement of coming into contact with the sampling or deposit surface should be perpendicular, whereby the prior movement optionally can be a pivoting movement or a sequence of translational motions in different directions. Drop 2′ is deposited by contact between point 3 and surface 2. The reserve of solution for the deposit of multiple drops 2′ is constituted by the inside volume (channel 3″) of point 3 and by an optional supplementary volume (cylinder with a larger diameter, for example) behind point 3.

In the case of a multipoint head 4, guiding device 8, 8′ can be common to all points 3 or specific to each one. The movement of approach and contact is obtained by the control of the Z axis of gantry 12 by an actuator 10 that is especially dedicated to this task or by the combination of the two above-mentioned actions (mixed device 7).

Device 7 for monitoring contact stresses between deposition point 3 and surface 2 is an essential element for obtaining quality micronetworks. Terminal surface 3″″ of the deposition point is flat and makes it possible to guarantee a maximum value of contact pressure (and therefore sealing) between point 3 and surface 2 by monitoring the point-surface interaction force. This force is monitored by a passive compliant device 9 or by an active device 10 (actuator), which ensures the quality of the deposition of drops as well as the hooking of molecules (of ADN, for example) to the surface. This device 7 as well as the shape of points 3 avoid the spraying of liquid on surface 3 as well as the explosion of drops 2′.

FIG. 3 diagrammatically shows a passive compliant device. This device 9 consists of a flexible element (such as a leaf spring) or a compressible element (such as a traction-compression spring) that exerts a force on point 3 or on a part 9′ that is integral with the point, whereby this force is regulated by a scaling element (for example a screw or washer that forms an adjusting shim) placed behind compliant device 9 opposite stop 9′ that is integral with micropipette 3 or on the same side as the latter. The interaction force with deposit surface 2 is therefore a resultant of the initial scaling force and the value of travel along the Z axis during the deposit.

FIG. 4 shows an embodiment of device 7 in the form of a mixed active device. This device consists of an actuator 10 that exerts a force on point 3 or on a part 9′ that is integral with point 3. This force is exerted either directly (not shown) or by means of a compliant device 9 (such as a spring) that is mounted between a load transmission part 10′ on which actuator 10 and part 9′ act. This part 10′ can, if necessary, be used as a scaling element.

The force for the movement and contact is created by an actuator 10 (electric, pneumatic or hydraulic). In the case of an electromagnetic actuator, for example an electromagnet or a linear engine, an electronic control device (not shown) makes it possible to control the exerted force. The force is measured either directly by a sensor 11 that is inserted between compliant device 9 and point 3 or indirectly by an observer model and the deformation measurement of the compliant device.

When there is no compliant device 9, the force is measured directly between actuator 10 and point 3.

The control of force makes it possible to monitor the interaction force with surface 2 and in particular its maximum value. This action makes it possible to guarantee that there is no damage to the surface, its coating or any other product that would have been deposited above, nor points 3 themselves. The control is carried out either by an analog, purely electronic device or by a digital system with a microprocessor or else by both at once. The setpoint is developed based on the task to be carried out (micronetwork) and the material or materials that are deposited on deposit surface 2 or that constitute the latter. Compliant device 9 makes it possible to absorb the shock during contact. In the absence of compliant device 9, the shock is dampened by a suitable choice of the setpoint of the closed-loop control.

FIG. 5 presents in detail the different functions relative to the unit for regulation and closed-loop control of the contact stresses. The value of the contact stress is obtained either by direct measurement of the latter or indirectly by the determination with a mechanical behavior equation and the measurement of a value of the same type or of a different nature. It is possible, for example, to determine the contact stress by the measurement of the travel of the point and the dynamic equation of the behavior of the moving portion (the determination technique can be based on an estimator or on an observer). The stage that feeds the actuator is, for example, an amplifier of power (for example, a so-called “push-pull” linear stage, a stage that is known under the designation MLI, etc.). The loops for regulation and closed-loop control consist of functions of measurement and/or observation/prediction, filtering, comparison, correction and generation of setpoint signals (control). The functions of observation/prediction, filtering, comparison, correction and generation of setpoint signals can be carried out in a known manner by a digital microprocessor device or by an analog solution.

The inventors have further noted that one of the possible difficulties that prevent a good reproducible deposition stems from the double function of terminal contact surface 3″″.

Actually, as FIGS. 2 to 4 of the attached drawings show, this surface 3″″ should both allow the adhesion of chemical or biological products and serve as a reference for stopping the translational motion along the perpendicular.

A solution can consist in separating the two functions, i.e., to provide a first surface 3″″ that carries out the deposition and a second surface 17′ that carries out the limitation of normal motion of micropipette 3 that is being considered.

FIGS. 8, 9A and 9B illustrate an embodiment of a micropipette that corresponds to the solution that is indicated above, used with small plates that comprise deposition sites or zones 6, 19 and support sites or zones 20.

In FIGS. 9A and 9B, two zones 19 and 20 are distinguished on the receiving substrate. Zone 19 is the deposit surface of chemical or biological products. Zone 19 is therefore coated with the same adhesive products (polylysine, silane, etc.) that are common in the production of micronetworks. Zone 20 does not receive any deposition of product and only has the function of stopping the motion along the axis that is perpendicular to the deposit surface.

In this case, micropipette 3 has a shape that is particularly suitable for the deposition operation. It has a contact or additional connector surface 17′ that comes into connection with zone 20. The contact pressure between the micropipette and zone 20 is limited by the same devices 5 to 7 as those that are reported above. Terminal surface 3″″ of micropipette 3 is designed to then be close to or just in contact with deposition zone 19. It is necessary, of course, to provide a level difference between surfaces 3″″ and 17′ that is compatible with the level difference of receiving surfaces 19 and 20. The central portion of micropipette 3 has the same characteristics as those that are described in connection with FIG. 2, namely a terminal surface 3″″, a conical surface 3″″, an essentially cylindrical surface 3′ and optionally a connector surface 3′″″. It is also always traversed by a circulation channel 3″ that comes out on surface 3″″.

As FIGS. 9A and 9B show, zones 19 and 20 can be located in mutually offset planes, like surfaces 17′ and 3″″.

Zone 18 forms a hollow that clearly separates surface 3′″ from surface 17′ and has the essential role of preventing the liquid that wets surface 3″″ from wetting surface 17′.

When zone 19 is located lower than zone 20, it is then possible to place another deposition in the vicinity without running the risk of touching the preceding deposition. FIG. 9A shows the position of micropipette 3 during a deposition that is close to a preceding deposition. The hollow in this case is selected with a depth that is greater than the height of the depositions formed above. FIG. 9B shows the case of a deposition with partial coating of the preceding deposition by micropipette 3.

A particular device is developed to make possible the cleaning of micropipettes 3. Another device is used to eliminate the liquid that wets surfaces 17′ and 18′ after a sampling.

For the use of the moving head, a unit consisting of capillaries and associated pressure chamber makes it possible to connect the deposition point or points to a pump (peristaltic or other) and makes it possible to circulate fluids (water, solvent, air, gas) inside the points. It thus ensures a double function: an effective cleaning during washing (described below) and a specific monitoring of the quantities of liquid handled (which is particularly important during the sampling of solutions of biological or chemical compounds), thus making it possible to conserve the solutions.

FIG. 6 shows a possibility for embodiment of a fluid circuit that is combined with moving head 4.

Pressure chamber 15 makes it possible to balance the pressures when several micropipettes or points 3 are monitored by the same channel of the pump. Deposition points 3 are connected to pressure chamber 15 by flexible connecting pipes 15′ and can optionally be connected to one another by connecting brackets 15″. Pressure chamber 15 can be a specific connecting element or can be constituted of connector pipes themselves. The role of the pressure chamber is to link the connected pipes at points 3 with pumps 16 or fluid storage reservoirs 16′ (pressurized or not). Solenoid valves that are controlled by the control unit (computer) are open based on washing or deposition processes. Solenoid valve EV1 monitors the pressure or partial vacuum of the chamber and the connector pipes via a gaseous fluid. Solenoid valve EV2 monitors the pressure or partial vacuum of the chamber and connector pipes via a liquid fluid. The liquid fluid is primarily used during the washing process. Solenoid valve EV3 makes it possible to connect the chamber and the connector pipes to the atmospheric pressure and thus to balance the pressures on both sides of the solution column that is contained in points 3.

The invention also has as its object a process for deposition of high-density networks of microdrops of solutions on a surface at least of the device described above, characterized in that it consists in bringing moving head 4 to a sampling site 5, in sampling, by quenching the ends of micropipettes 3, in wells or similar containers of a sampling site 5, a determined quantity of the solutions that are present in these containers, in transferring moving head 4 to a deposition site 6, to deposit, in the form of a microdrop network 2′, a determined quantity of solutions that are sampled on deposit surface 2 relying on controlled stress of said pipettes 3 on said surface 2, optionally in repeating this deposition operation one or more times by successively moving moving head 4 toward one or more other deposition sites 6, in moving moving head 4 toward evacuation and washing station 14 and in initiating the cleaning of micropipettes 3 and other elements that have been in contact with the sampled solutions, with a view to their decontamination, and in repeating all of the above-cited operations until the solutions to be sampled are used up and/or deposit surface 2 is saturated.

The latter can be constituted by the surface of a substrate or any small plate, for example a small silicon plate that is part of a biochip.

Washing or cleaning points 3 can be broken down into several stages:

The disposal of solutions contained in the points,

The cleaning of the points by repetition of a series of solvent-product intake and dumping actions,

The cleaning of terminal surface 3″″ of the points by bringing them into repeated contact with a surface that is coated by a product that can adhere to said product the solution residues that are again deposited or glued to said terminal surface 3″″, preferably a product that is identical to the one that coats deposition sites 6 (for example polylysine),

The drying of the points by a jet of air or another gas.

Of course, the invention is not limited to the embodiments that are described and shown in the attached drawings. Modifications are possible, in particular from the viewpoint of the constitution of the various elements or by substitution of equivalent techniques, without thereby leaving the field of protection of the invention.

1. Device for sampling and deposition on a surface, in the form of microdrops, of, in particular, chemical or biological solutions that comprise at least one micropipette or deposition point that is mounted on a moving head in at least one direction, at least between one or more sampling site(s) and one or more deposition site(s), characterized in that micropipette or micropipettes (3) are hollow and are mounted in the body of said head (4), with relative transportability relative to the latter, via a device (7) for monitoring and limiting application stresses of micropipette or micropipettes (3) on deposit surface (2), combined with a device (8, 8′) for guiding the latter relative to said head (4), during or for the purpose of bringing them into contact with said surface (2).

2. Device according to claim 1, wherein each micropipette (3) has a body (3′) that may or may not be cylindrical, traversed longitudinally by a channel (3″) and having a tapered end (3′″), for example of an essentially conical shape, ending by a terminal contact surface (3″″) that is annular and flat.

3. Device according to claim 2, wherein tapered end (3′″) has, before coming out on terminal contact surface (3″″), a connector surface (3″″) that carries out a continuous passage between the conical surface of tapered end (3′″) and planar contact surface (3″″), advantageously generated by a parabolic curve portion.

4. Device according to any of claims 2 and 3, wherein each micropipette (3) is provided, at its free end or deposition tip, with an essentially annular protuberant formation (17) that may or may not be circumferentially continuous and that surrounds tapered end (3′″) and that is separated from the latter by an annular reinforcing zone (18) that is formed or provided in said end of body (3′) of micropipette (3) that is being considered, whereby said annular protuberant formation (17) ends in a planar terminal contact surface (17′), located in a parallel plane, and if necessary, combined with the plane that comprises contact surface (3″″) of tapered end (3′″).

5. Device according to claim 4, wherein contact surfaces (3″″ and 17′) are offset to one another in the longitudinal direction of body (3′) of each micropipette (3) and wherein sites for sampling (5) and deposition (6) are located in corresponding hollows or supports (19).

6. Device according to any of claims 2 to 5, wherein outside diameter (D) of annular contact surface (3″″) or terminal diameter is essentially equal to the diameter of microdrops (2′) to be obtained and wherein the d/D ratio between said terminal diameter (D) and inside diameter (d) of said contact surface (3″″) has a value of between 0.2 and 0.8.

7. Device according to any of claims 1 to 6, wherein guiding device (8, 8′), specific to each micropipette (3) or common to all micropipettes (3), ensures double guiding of translational motions of body (3′) of each micropipette (3), at two guiding zones (8 and 8′) that are spaced relative to moving head (4) in body (4′) of which it is mounted.

8. Device according to any of claims 1 to 7, wherein each device for monitoring and limiting stress (7) consists of a passive compliant device (9), such as an elastically flexible or compressible intermediate element that ensures controlled transmission of thrust loads and translational motion between body (4′) of moving head (4) and micropipette (3) that is concerned.

9. Device according to any of claims 1 to 7, wherein each device for monitoring and limiting stress (7) consists of an active device in the form of an actuator (10) that is integral with moving head (4), acting directly on body (3′) of micropipette (3) that is being considered or on a part for transmission of stresses (10′) that is formed or fixed on the latter for its contact with surface (2) and monitored by means of a loop for regulation and closed-loop control that also integrates a means for measurement or direct or indirect determination (11) of the force of application of said micropipette (3) to deposit surface (2).

10. Device according to claims 8 and 9, wherein each device for monitoring and limiting stress (7) consists of a mixed device integrating an actuator (10) that is controlled by a loop for regulation and closed-loop control that integrates a means for measurement or direct or indirect determination (11) and that acts on micropipette (3) combined by a passive compliant device (9).

11. Device according to any of claims 1 to 10, wherein moving head (4) comprises a number of micropipettes (3) that are arranged in rows and in columns according to a two-dimensional matrix structure.

12. Device according to any of claims 1 to 11, wherein the quantity of liquid that is sampled and deposited by each micropipette (3) is monitored via means (15, 15′, EV1, EV2, EV3) that produce a pressure variation of a gas at the end of micropipette (3) opposite to its free end or deposition tip.

13. Device according to any of claims 1 to 12, wherein it also comprises, on the one hand, an arm or a gantry (12) that carries moving head (4) and allows at least the travel of micropipettes (3) in a plane, preferably in two orthogonal directions (Y and Z), and, on the other hand, a support plane (13) on which are placed site or sites (5) for sampling solutions, for example in the form of small plates, wells or similar containers, sites (6) for the deposition in micronetworks of microdrops (2′) of solutions sampled by micropipettes (3) and a site or a station (14) for evacuation and washing of said micropipettes (3), whereby arm or gantry (12) can be translated in a direction (X) that is approximately perpendicular to plane (Y, Z) of the travel of micropipettes (3) that are mounted on moving head (4).

14. Device according to claim 13, wherein sites for sampling and deposition (5 and 6) are placed on small plates or in receptacles (5′ and 6′) that move independently in directions (X, X1) that are parallel to one another and perpendicular to the plane that contains two directions (Y and Z) for travel of micropipettes (3) that are mounted on moving head (4).

15. Process for high-density network deposition of microdrops of solutions on a surface by means of the device according to any of claims 1 to 14, wherein it consists in bringing moving head (4) to a sampling site (5) to sample, by quenching the ends of micropipettes (3) in wells or similar containers of a sampling site (5), a determined quantity of solutions that are present in these containers to transfer moving head (4) toward a deposition site (6), in depositing, in the form of a microdrop network (2′), a determined quantity of solutions that are sampled on deposit surface (2) by support with controlled stress of said pipettes (3) on said surface (2) optionally to repeat one or more times this deposition operation by successively moving moving head (4) toward one or more other deposition sites (6), in moving moving head (4) toward evacuation and washing station (14) and in initiating the cleaning or washing of micropipettes (3) and other elements that have been in contact with the sampled solutions, with a view to their decontamination, and in repeating all of the above-cited operations until the solutions to be sampled are used up and/or deposit surface (2) is saturated.

16. Process according to claim 15, wherein the cleaning of micropipettes (3) comprises in particular the cleaning of terminal surface (3″″) of points by their repeated contact with a surface that is coated by a product that can adhere to said product the solution residues that are also deposited or glued to said terminal surface (3′″), preferably a product that is identical to the one that coats deposition sites (6).
